(19) United States
(12) Patent Application Publication
(10) Pub. No.: US 2015/0258354 A1
(43) Pub. Date: Sep. 17, 2015

(54) BELAY BAR

(71) Applicant: David James Lyon, Kingston, WA (US)

(72) Inventor: David James Lyon, Kingston, WA (US)

(21) Appl. No.: 14/644,190

(22) Filed: Mar. 10, 2015

Related U.S. Application Data
(60) Provisional application No. 61/952,805, filed on Mar. 13, 2014.

(51) Int. Cl. A62B 1/14

(52) U.S. Cl. CPC A62B 1/14

(57) ABSTRACT

An enhanced belay bar, comprising a rigid tube affixed to rigid plates, each comprising a plurality of attachment surface and attachment points to affix the belay device to a surface, and a plurality of attachment points to affix an automatic belay device to the enhanced belay bar.

### CROSS-REFERENCE TO RELATED APPLICATIONS

This application claims priority to U.S. provisional patent application Ser. No. 61/952,805, titled “IMPROVED BELAY BAR”, filed on Mar. 13, 2014, the entire specification of which is incorporated hereby by reference.

### BACKGROUND OF THE INVENTION

1. Field of the Invention

The present invention is in the field of indoor climbing equipment, and more particularly in the field of devices for safely supporting automated belay devices.

2. Discussion of the State of the Art

The field of recreational indoor climbing has exploded in popularity. As wider sporting audiences have engaged in indoor climbing, including many participants with minimal experience and safety knowledge, it has proven useful to provide automated belay devices to assist in safe fall control; such automated belay devices act to stop a climber's fall without requiring the climber to take any action. However, introduction of automated belay devices has caused additional problems. Such devices tend to be heavy metal discs suspended from near the top of an indoor climbing wall or similar climbing venue. With use, the automated belay devices tend to cause accelerated wear and tear on the climbing wall itself, and to cause chafing of ropes that pass through them, requiring more frequent replacement of climbing ropes than previously.

What is needed is a device capable of sustaining substantial static and dynamic loads and comprising means of safely suspending an automated belay device at a distance from a climbing wall to reduce the wear and tear on the wall and on the ropes used in climbing.

### SUMMARY OF THE INVENTION

The inventor has accordingly conceived and reduced to practice a novel and enhanced belay bar suitable for addressing the problems cited above that were introduced with the use of automated belay devices.

According to a preferred embodiment of the invention, an enhanced belay bar may comprise a rigid tube (such as constructed of a strong metal or polymer composite, or other material or combination of materials suitable for use in climbing devices) that may be partially affixed to or embedded within (such as by integrally manufacturing as a single piece, or by welding metal pieces together to form a single rigid structure) two rigid plates (again, such as may be constructed of a strong metal or other suitable materials or combination of materials for climbing uses), such that at least a portion of the tube is exposed below the plates (that is, in the direction of the ground). This design may reduce wear on a climbing rope or other tether (such as cable, webbing, or other such materials common in the art) by reducing contact surfaces that may cause friction during use, and also by minimizing the risk of friction against an exposed edge or sharp angle (such as where the tube is connected to the plates). To further reduce the risk of wear, exposed edges may be rounded or chamfered to smooth out any sharp angles and reduce abrasive surfaces, and contact surfaces may be polished or covered in a smooth abrasion-resistant or low-friction coating or material (such as a polymer, paint, or graphite coating designed to facilitate low-friction movement over the surface to which it is applied). In these ways climber safety may be improved by reducing the likelihood of catastrophic failure of their climbing tether, as well as increasing durability of such tethers and reducing the need for frequent replacement.

Further according to the embodiment, the rigid plates of the device may further comprise a plurality of angled or perpendicular (relative to the rigid plate surface) attachment surfaces, such as bent or attached metal (or other suitable material) plates, each of which may further comprise a plurality of attachment points such as mounting holes or devices, such as may be utilized to affix an enhanced belay bar to a surface such as a rock face or a climbing wall. In this manner it may be possible to affix an enhanced belay device in a variety of ways and in a variety of orientations, to a variety of surfaces according to its intended use, according to the invention. For example, an enhanced belay bar may be affixed to a non-flat surface such as a rough climbing wall designed to simulate a natural rock formation, by utilizing angled attachment surfaces designed to accommodate the shape of the surface. Additionally, in some application it may be possible to reinforce the attachment through the use of multiple attachment points or devices, to improve climber safety and reduce strain or wear on the equipment (such as a climbing wall or the enhanced belay bar itself).

According to another preferred embodiment of the invention, an enhanced belay bar may further comprise a plurality of attachment points such as mounting holes or attachment devices (such as carabiners or similar clip- or snaplink-style attachment means) attached to or embedded within (such as integrally-formed mounting holes) the rigid plates described above. Such attachment points may then be used to affix various climbing equipment such as an automatic belay device (also known as auto-belay, self-belay, or assisted braking devices in the art) for use in various climbing activities such as solo climbing (without the use of a second person to belay a climber, by instead using an auto-belay device). As envisioned by the inventor, such attachment points may be positioned at a distal end of an enhanced belay bar (relative to a climbing surface to which it is attached), and the rigid plates may be tapered such as to reduce the likelihood of such an affixed auto-belay device from coming into contact with them during use, and thereby reducing wear on both the auto-belay device and the enhanced belay bar. Additionally, such a configuration allows for a suitable distance between an auto-belay device and a climbing surface, such that during use they may not come into contact, again reducing wear to an auto-belay device as well as a climbing surface.

### BRIEF DESCRIPTION OF THE DRAWING FIGURES

The accompanying drawings illustrate several embodiments of the invention and, together with the description, serve to explain the principles of the invention according to the embodiments. One skilled in the art will recognize that the particular embodiments illustrated in the drawings are merely exemplary, and are not intended to limit the scope of the present invention.

FIG. 1 is a side view of an enhanced belay bar, according to a preferred embodiment of the invention.

FIG. 2 is a view showing an arrangement of structural supports for an enhanced belay bar, according to a preferred embodiment of the invention.

FIG. 3 is a view of an enhanced belay bar supporting an automated belay device, according to a preferred embodiment of the invention.

FIG. 4 is a view of an alternate configuration of an enhanced belay bar supporting an automated belay device.

FIG. 5 is a view of an alternate configuration of an enhanced belay bar supporting an automated belay device.

### DETAILED DESCRIPTION

One or more different inventions may be described in the present application. Further, for one or more of the inventions described herein, numerous alternative embodiments may be described; it should be understood that these are presented for illustrative purposes only. The described embodiments are not intended to be limiting in any sense. One or more of the inventions may be widely applicable to numerous embodiments, as is readily apparent from the disclosure. In general, embodiments are described in sufficient detail to enable those skilled in the art to practice one or more of the inventions, and it is to be understood that other embodiments may be utilized and that structural, logical, software, electrical and other changes may be made without departing from the scope of the particular inventions. Accordingly, those skilled in the art will recognize that one or more of the inventions may be practiced with various modifications and alterations. Particular features of one or more of the inventions may be described with reference to one or more particular embodiments or figures that form a part of the present disclosure, and in which are shown, by way of illustration, specific embodiments of one or more of the inventions. It should be understood, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described, it will be readily apparent that more than one device or article may be used in place of a single device or article. Similarly, where more than one device or article is described, it will be readily apparent that a single device or article may be used in place of the more than one device or article.

Techniques and mechanisms described or referenced herein will sometimes be described in singular form for clarity. However, it should be noted that particular embodiments include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### DESCRIPTION OF EXEMPLARY EMBODIMENTS

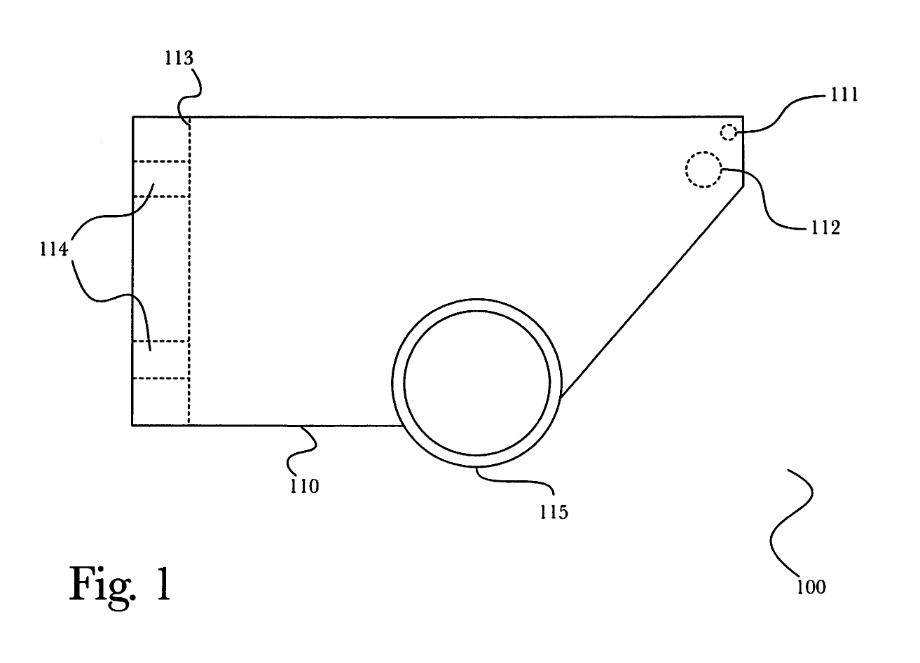

FIG. 1 is a side view of an enhanced belay bar 100, according to a preferred embodiment of the invention. According to the embodiment, a rigid plate 110 may be affixed to a rigid hollow tube 115, such that a portion of the tube 115 may be exposed to allow for increased range of movement of a rope that may be passed over the tube (as may be used for top-rope climbing techniques), as well as to decrease surface area friction of an enhanced belay bar 100 against a rope (i.e., contact surfaces between a rope passed over tube 115 and an enhanced belay bar device, for example contact with the tube 115 and adjacent portions of rigid plate 110) and thus decelerate rope wear. The means of attachment may be integral (such as a metal tube welded onto a metal rigid plate), or semi-fixed or removable, interchangeably according to the invention, however as envisioned by the inventor a permanent, integrally fixed arrangement should be ideal for structural strength and to ensure safety of climbers utilizing an enhanced belay bar 100. Additionally, the specific amount of exposure of a hollow tube 115 may vary according to a particular arrangement, and the amount of exposed tube shown is shown as an exemplary arrangement for illustration of function. It should also be appreciated that various edges of rigid plates 110 may be rounded, chamfered, or otherwise designed in such a manner as to reduce abrasion when contacting a climbing tether such as a rope, cable, or webbing (as are common in the art), to reduce wear and improve climber safety during use.

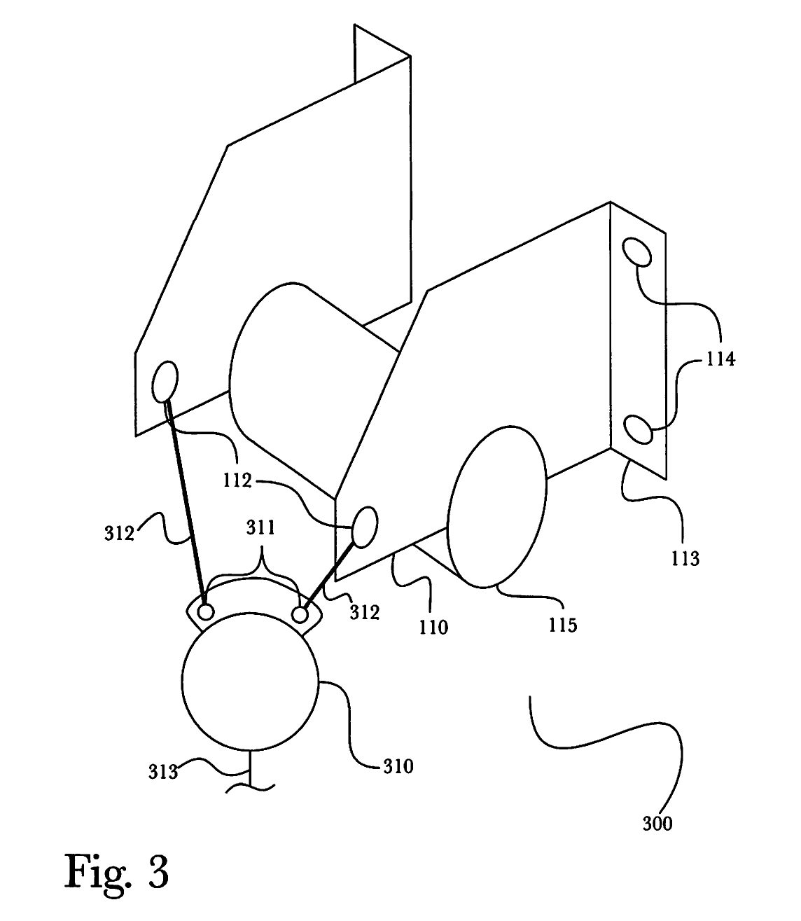

As further illustrated, a rigid plate 110 may comprise perpendicular “wings” or rigid plate attachment surfaces 113 (shown below in perspective for clarity, referring to FIG. 3), which may further comprise a plurality of mounting holes 114 or similar attachment means to affix an enhanced belay bar 100 to a surface such as a rock face or climbing wall, according to its intended use. In this manner, an enhanced belay bar 100 may be permanently or removably fixed to a climbing surface to ensure stability during use and increase climber safety and confidence.

As further illustrated, a plurality of attachment points 111, 112 may be utilized at a distal portion (relative to an affixed climbing surface) of an enhanced belay bar 100, for such purposes as to affix additional climbing equipment such as flags or markers, additional safety tethers or ropes, or assisted or automatic belay devices (as shown below, referring again to FIG. 3). In this manner, a single enhanced belay bar 100 may server multiple uses according to the specific nature of a climbing activity being performed or the preference of a particular climber utilizing the device.

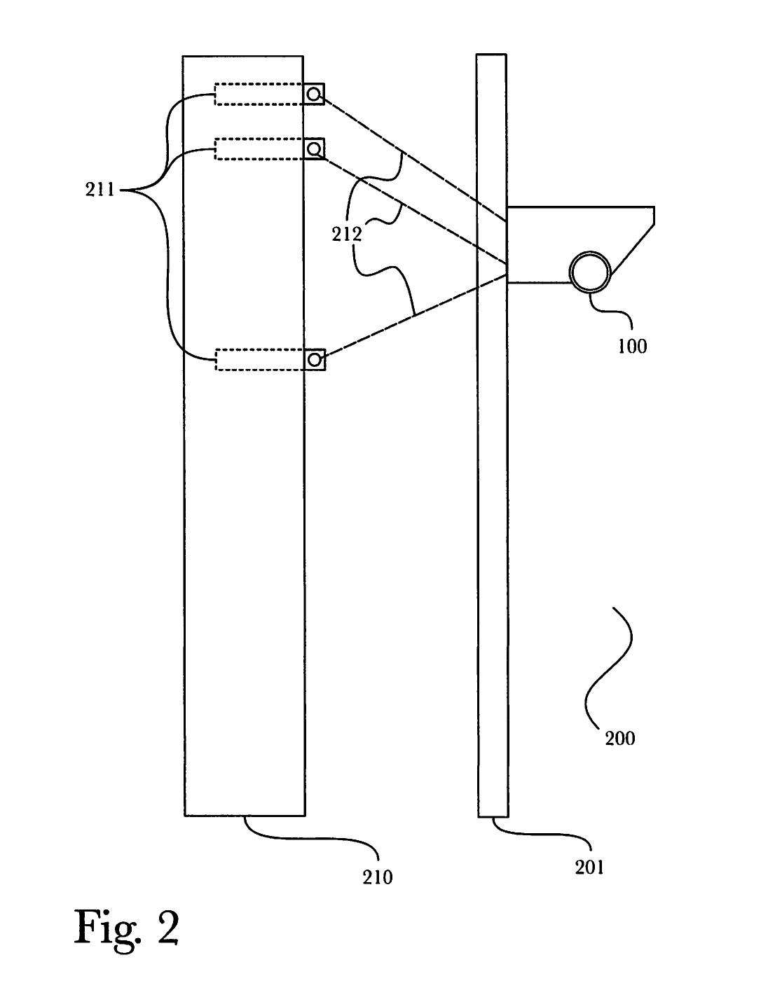

FIG. 2 is a view showing an arrangement 200 of structural supports for an enhanced belay bar 100, according to a preferred embodiment of the invention. According to the embodiment, an enhanced belay bar 100 may be affixed (such as via attachment points 114, described previously in FIG. 1) to a rigid climbing surface 201 such as a wall or rock face. As illustrated, if an artificial climbing wall is utilized (as is common in the art, for example in indoor recreational climbing facilities), a support surface 210 such as a concrete or other reinforced wall may be utilized to anchor an enhanced belay bar 100 for additional strength and safety. As illustrated, a plurality of attachment devices such as eye bolts 211 or similar rigid, high-strength attachment means may be utilized to anchor a plurality of structural tethers 212 such as cables, chains, or other appropriate high-strength flexible attachments, that may in turn be affixed to an enhanced belay bar 100 such as by attaching or passing through attachment points described above (again, referring to FIG. 1). In this manner, the strain produced during use of an enhanced belay bar 100 may be distributed between multiple tethers or anchors, as well as multiple structural components such as the climbing surface 201 and support wall 210, to reduce the likelihood of any single component failure and increase climber safety. It should be appreciated that the specific quantity and arrangement of attachment devices 211, tethers 212, and surfaces 210 may vary according to the invention and as may be needed for a particular arrangement or use case, and the number and arrangement shown are used for illustrative purposes.

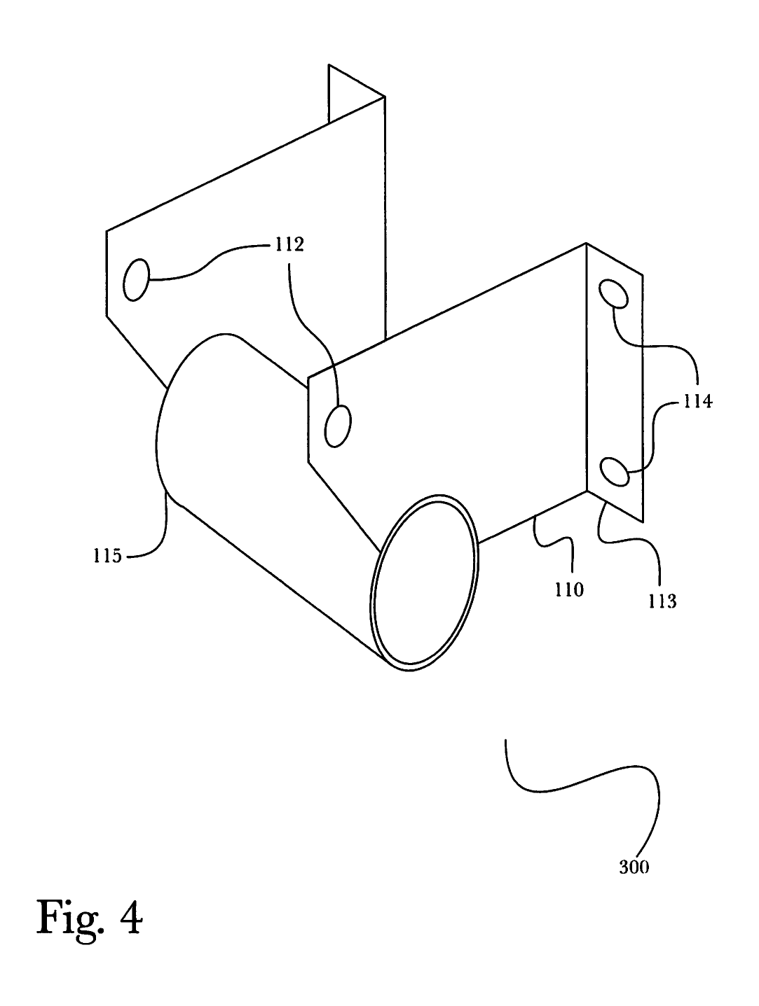

FIG. 4 is a view of an alternate configuration of an enhanced belay bar supporting an automated belay device 310, according to a preferred embodiment of the invention. As illustrated, an enhanced belay bar may comprise a smooth rigid tube 115 affixed to rigid plates 110 that may further comprise perpendicular or angled attachment surfaces 113, which may further comprise a plurality of attachment points 114 such as for anchoring within or upon a climbing surface (as illustrated previously, referring to FIG. 2). As further illustrated, rigid plates 110 may further comprise a plurality of attachment points 112 at a distal end (relative to attachment points 114 and therefore relative to a surface to which the belay bar may be affixed, as shown above in FIG. 2), that may be utilized for such purposes as attachment of external devices such as described above (referring to FIG. 3).

According to the embodiment, an enhanced belay bar may be oriented such that a tapered edge of a rigid plate 110 is tapered in a downward direction (as illustrated in FIG. 3), or alternately in an upward-tapering direction, as is illustrated in the configurations shown in FIGS. 1 and FIG. 4. It should be appreciated that any other suitable orientation may be utilized according to its intended use, according to the invention. In this manner, an enhanced belay device may be manufactured or affixed in a variety of ways to facilitate a particular use, such as to accommodate multiple attachments or multiple climbers simultaneously, or any other such use as may be desired during operation.

FIG. 3 is a view of an enhanced belay bar supporting an automated belay device 310, according to an alternate embodiment of the invention. As illustrated, an enhanced belay bar may comprise a smooth rigid tube 115 affixed to rigid plates 110 that may further comprise perpendicular or angled attachment surfaces 113, which may further comprise a plurality of attachment points 114 such as for anchoring within or upon a climbing surface (as illustrated previously, referring to FIG. 2). As further illustrated, rigid plates 110 may further comprise a plurality of attachment points 112 at a distal end (relative to attachment points 114 and therefore relative to a surface to which the belay bar may be affixed, as shown above in FIG. 2), to which may be affixed an automatic or assisted belay device 310 such as by connecting an attachment point 112 on an enhanced belay bar to an attachment point 311 on a belay device 310. It should be appreciated that the means of affixing the belay device 310 may vary, and it may be affixed in either a permanent or removable fashion, such as by using a cable 312 or similar tether (such as a rope, chain, or other suitable attachment means), or by using a rigid or semi-rigid attachment such as a carabiner or snaplink (as opposed to a flexible tether as illustrated), interchangeably according to the embodiment. Belay device 310 may then be connected to a plurality of climbers according to its design or particular use, such as by integral or removable tether 313, such as a climbing rope or webbing material, as are commonly used in the art.

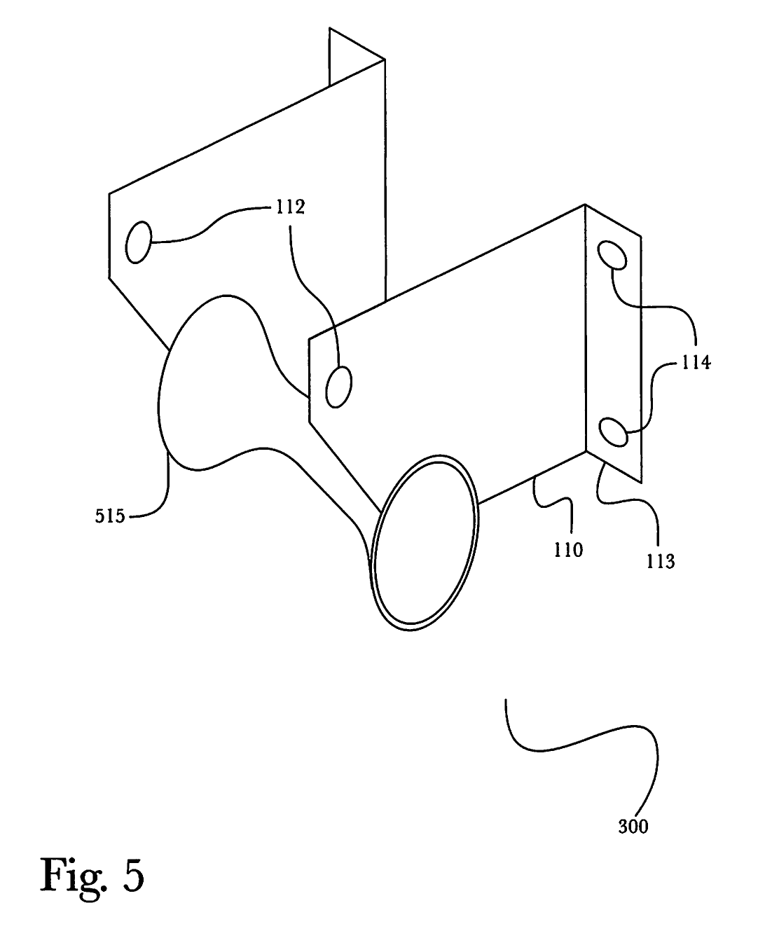

FIG. 5 illustrates an additional alternate configuration of an enhanced belay bar, utilizing a curved rigid tube 515 affixed to rigid plates 110 that may further comprise perpendicular or angled attachment surfaces 113, which may further comprise a plurality of attachment points 114 such as for anchoring within or upon a climbing surface (as illustrated previously, referring to FIG. 2). As further illustrated, rigid plates 110 may further comprise a plurality of attachment points 112 at a distal end (relative to attachment points 114 and therefore relative to a surface to which the belay bar may be affixed, as shown above in FIG. 2), that may be utilized for such purposes as attachment of external devices such as described above (referring to FIG. 3).

According to the embodiment, a rigid tube 515 may be designed such as to minimize friction and abrasion of a climbing tether, rope, or other such attached component. In this manner climber safety and equipment longevity may be enhanced through the use of simple alternate mechanical configuration as illustrated, and it should be appreciated that such a curved design may be utilized in various configurations in addition to, or as a substitute for, a rigid bar 115 according to various arrangements such as those illustrated previously (referring to FIGS. 3 and 4), according to the invention.

The skilled person will be aware of a range of possible modifications of the various embodiments described above. Accordingly, the present invention is defined by the claims and their equivalents.

What is claimed is:

1. An enhanced belay bar device, comprising:
a rigid tube; and
A plurality of rigid plates.
wherein the rigid tube is affixed to the rigid plates, such that a portion of the tube is exposed, and
wherein the rigid plates are designed to facilitate the affixing of the enhanced belay bar device to a surface.

2. The device of claim 1, wherein the rigid components are constructed of a strong metal.

3. The device of claim 1, wherein all exposed edges are rounded.

4. The device of claim 1, further wherein the rigid plates further comprise a plurality of angled attachment surfaces.

5. The device of claim 4, wherein the attachment surfaces each further comprise a plurality of attachments points.

6. The device of claim 5, wherein the attachment surfaces are perpendicular to the rigid plates.

7. The device of claim 1, wherein the rigid plates each further comprise a plurality of attachment points for belay devices.

8. The device of claim 7, wherein the attachment points are holes passing through the rigid plates.

9. The device of claim 7, wherein the attachment points are positioned at a distal end of the rigid plates relative to the surface.
